(19) United States
(12) Patent Application Publication
(10) Pub. No.: US 2026/0111852 A1
(43) Pub. Date: Apr. 23, 2026

(54) System

(71) Applicant: Softbank Group Corp., Tokyo (JP)

(72) Inventor: Kazuki Ikegami, Minato-ku (JP)

(21) Appl. No.: 19/360,438

(22) Filed: Oct. 16, 2025

(30) Foreign Application Priority Data
Oct. 21, 2024 (JP) 2024-185548

(51) Int. Cl. G06Q 10/20; G06T 7/00

(52) U.S. Cl. CPC G06Q 10/20; G06T 7/0004; G06T 2207/20084

(57) ABSTRACT

A system includes a processor that is configured to acquire image data of a target structure using an image acquisition device, analyze the image data using artificial intelligence to determine a deterioration condition of the structure, identify repair locations and assign priorities based on the analysis result, generate an optimal reinforcement plan based on the assigned priorities, and present the reinforcement plan to a user.

### CROSS-REFERENCE TO RELATED APPLICATION

This application is based on and claims priority under 35 USC 119 from Japanese Patent Application No. 2024-185548 filed on Oct. 21, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional infrastructure maintenance and management, the process of identifying deterioration and formulating repair or reinforcement plans is often manual, time-consuming, and subject to human error. There is a lack of an efficient system that can objectively analyze the condition of structures and propose optimal reinforcement plans. Furthermore, existing solutions do not readily accommodate user feedback or integrate regional information for disaster response planning, resulting in inefficient resource allocation and delayed interventions.

### SUMMARY

The present invention provides a system comprising a processor configured to acquire image data of a target structure, analyze the data using artificial intelligence to determine deterioration, identify and prioritize repair locations, generate an optimal reinforcement plan, and present the plan to a user. The system further allows users to input additional information concerning the reinforcement plan via a communication device. Additionally, the system integrates the deterioration analysis results and reinforcement plans with regional information and stores them in a database, enabling effective response planning in the event of a disaster.

“Processor” means a hardware or software component capable of executing instructions to perform data processing, analysis, and control functions within the system.

“Image acquisition device” means a device, such as a camera or smartphone, capable of capturing image data of a target structure for analysis.

“Image data” means digital data representing visual information of a target structure captured by an image acquisition device.

“Artificial intelligence” means computer algorithms or models capable of analyzing image data, identifying patterns, and making determinations about the condition of a structure.

“Deterioration condition” means the physical state or degree of damage, wear, or degradation observed in a structure.

“Repair location” means a specific area of a target structure identified as requiring maintenance or reinforcement due to deterioration.

“Priority” means an assigned level of importance or urgency for addressing a repair location, determined based on the deterioration condition and other factors.

“Reinforcement plan” means a proposed strategy, including steps, materials, and schedules, for repairing or strengthening a deteriorated structure.

“User” means an individual or entity interacting with the system, typically responsible for managing or maintaining a structure.

“Communication device” means a terminal or apparatus, such as a smartphone, tablet, or computer, used by the user to interact with the system.

“Regional information” means data relating to the geographic area or locality relevant to the target structure, which may include location, environmental, and infrastructure details.

“Database” means an organized collection of digital records for storing image data, analysis results, reinforcement plans, and regional information.

“Disaster response planning” means the strategic process of preparing and organizing actions and resources to mitigate and recover from natural or man-made disasters affecting infrastructure.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or”is employed to link three or more items in the present specification.

### First Exemplary Embodiment

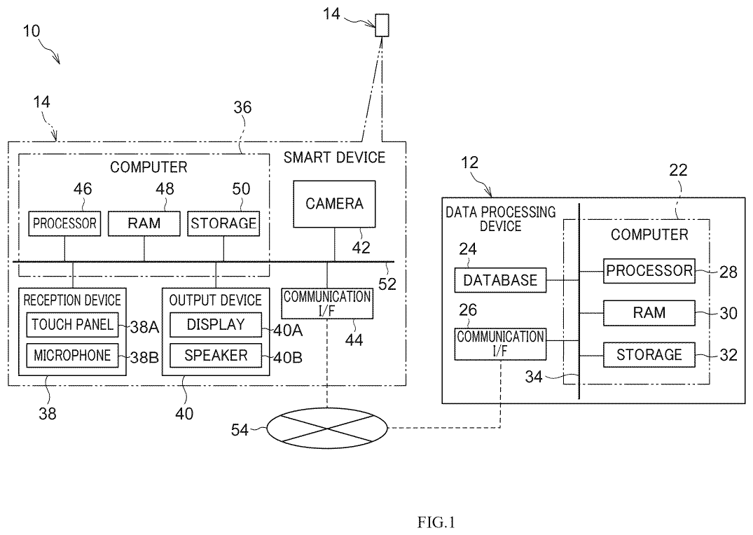

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

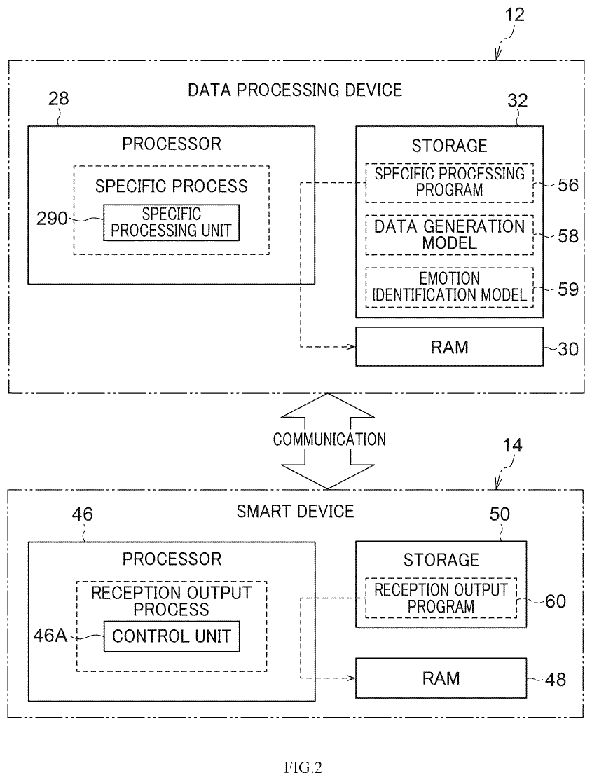

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

There are significant challenges in accurately and efficiently diagnosing the deterioration of buildings and infrastructure, and in providing optimal repair planning. Conventional approaches are limited in their ability to precisely identify deteriorations and to allocate resources for repairs effectively. There is also a need for improved integration of user-specific requirements and for flexible adjustment of repair plans based on real-time user inputs. Furthermore, there is a challenge in securely handling large-scale image data and utilizing analytical results for emergency response planning.

The specific processing by the specific processing unit 290 of the data processing device 12 in Example 1 is realized by the following means.

The present invention provides a server comprising a processor configured to acquire image information of a target facility, to process and analyze the image information using a generative artificial intelligence model, to automatically identify and prioritize repair locations, to generate a reinforcement plan, and to reflect user instructions input via a user terminal into the reinforcement plan, and further, to store the analysis results and reinforcement plans in association with area information for use in emergency response. This enables accurate and efficient deterioration diagnosis, user-customizable and optimal repair planning, secure image data processing, and the effective use of analytical results for disaster management.

The term “processor” refers to a computing unit or circuitry capable of executing instructions to process data and perform operations as specified in the system.

The term “image information” refers to digital data representing images or videos that indicate the condition of a target facility, including but not limited to photographs and video recordings.

The term “data acquisition device” refers to hardware used for capturing image information from a target facility, such as cameras, smartphones, drones, or other imaging equipment.

The term “data processing device” refers to any apparatus, such as a computer server or cloud computing infrastructure, used to receive, store, decrypt, decompress, and analyze image information.

The term “encryption” refers to the process of converting data into a secure format that prevents unauthorized access during transmission or storage.

The term “compression” refers to the process of reducing the size of data files without significant loss of information, to facilitate efficient storage and transmission.

The term “generative artificial intelligence model” refers to an artificial intelligence system, such as a neural network based on machine learning, that can analyze and generate information, including identifying patterns in images and interpreting user input.

The term “damage patterns” refers to specific characteristics or anomalies in image information that indicate deterioration, such as cracks, corrosion, or deformation.

The term “repair location” refers to a specific part or area of a target facility identified as requiring repair based on analysis of the image information.

The term “priority” refers to a ranking or score assigned to each repair location, reflecting the importance, urgency, or severity of the required repair.

The term “reinforcement plan” refers to a structured schedule and list of repair processes, materials, and work assignments generated for the purpose of repairing and maintaining a target facility.

The term “user terminal” refers to an electronic device, such as a computer, tablet, or smartphone, used by an end user to interact with the system.

The term “user interface” refers to the graphical or textual interface through which a user interacts with the system, such as a web page or application screen.

The term “instruction sentence” refers to a directive written by a user to specify preferences or requirements for the reinforcement plan.

The term “data set” refers to a collection of related data, including analysis results, reinforcement plans, and associated area information, stored for further reference and use.

The term “area information” refers to data that identifies the location or geographic context of a target facility or repair location, which may include regional, positional, or mapping details.

The term “emergency response plan” refers to a predefined set of actions or strategies for rapid and effective response to emergencies, such as natural disasters, utilizing prepared analysis results and reinforcement plans.

One embodiment for implementing the present invention will be described below. The system consists of at least a data acquisition device (such as a camera-equipped smartphone, tablet, or drone), a terminal (which could be a smartphone, tablet, or personal computer), and a server comprising a processor. The server is connected to the terminal and the data acquisition device via a communication network. The server further incorporates software modules for image processing, encryption, data storage, and artificial intelligence-based analysis, including at least one generative AI model. Examples of suitable hardware and software include smartphones with high-resolution cameras, commercially available drones, encryption software such as OpenSSL or built-in device security libraries, and AI frameworks such as TensorFlow or PyTorch on a Linux-based or cloud server system.

The user uses the data acquisition device to capture images and/or videos of the target facility or structure. For example, the user may use a smartphone camera or an unmanned aerial vehicle to capture detailed visual information of buildings, bridges, or infrastructure from multiple angles. The captured image information is then transferred to the terminal device, which acts as an intermediary between the data acquisition device and the server.

The terminal receives the image information, compresses it using a lossless data compression algorithm such as PNG encoding or a ZIP utility, and encrypts it using encryption protocols such as AES or other industry-standard methods. The terminal then transmits the compressed and encrypted image data to the server using secure communication protocols like HTTPS.

The server receives the uploaded data and performs decryption and decompression to restore the original image data. The server's data processing modules then organize and format the image information for efficient analysis. The processor in the server executes a generative artificial intelligence model, implemented with software such as PyTorch or TensorFlow, for automated examination of the images. The AI model extracts relevant features, identifies damage patterns (such as cracks, corrosion, or deformation), and outputs a set of detected deterioration locations.

Based on the evaluated results, the server generates a list of repair locations, each with an automatically assigned priority that reflects the severity and urgency of the deterioration. The processor further creates a reinforcement plan including recommended repair methods, material lists, and an optimized repair schedule. This plan is transmitted to the user terminal through a user interface, such as a customizable web dashboard or app. The user can review the reinforcement plan via the terminal and enter additional requirements or instructions in the form of natural-language prompt sentences, such as “Prioritize repairs for the columns first” or “Limit the repair plan to items within a budget of $10,000.” The server analyzes such instruction sentences using a generative AI language model, such as GPT-4, and flexibly reflects the user's requirements by recalculating priorities, updating scheduling, or modifying the scope of work as needed.

As an example, a municipal employee may use a drone to capture images of an aging bridge, upload those images via a secure tablet application, and then receive an automatically generated repair plan indicating priority areas for intervention. If required, the employee can submit prompt sentences such as:
“Please assign the highest priority to any identified damages on the eastern support structure.”
“Can you generate a minimal repair plan that stays within $10,000?”
“Schedule cable maintenance before the rainy season in July.”
The server interprets these user instructions and adjusts the repair and reinforcement plan accordingly before sending the final version to the user's terminal.

The system further enables storage of analytical results and reinforcement plans in association with geographic or area information in a central data repository. This allows effective utilization of the results for emergency response or disaster management.

In this way, the invention enables an integrated workflow from data acquisition and secure image information transfer, through automated AI-based damage analysis and repair planning, to interactive customization of the plan based on user input. The invention provides for efficient, accurate, and flexible infrastructure maintenance and management utilizing generative AI technology.

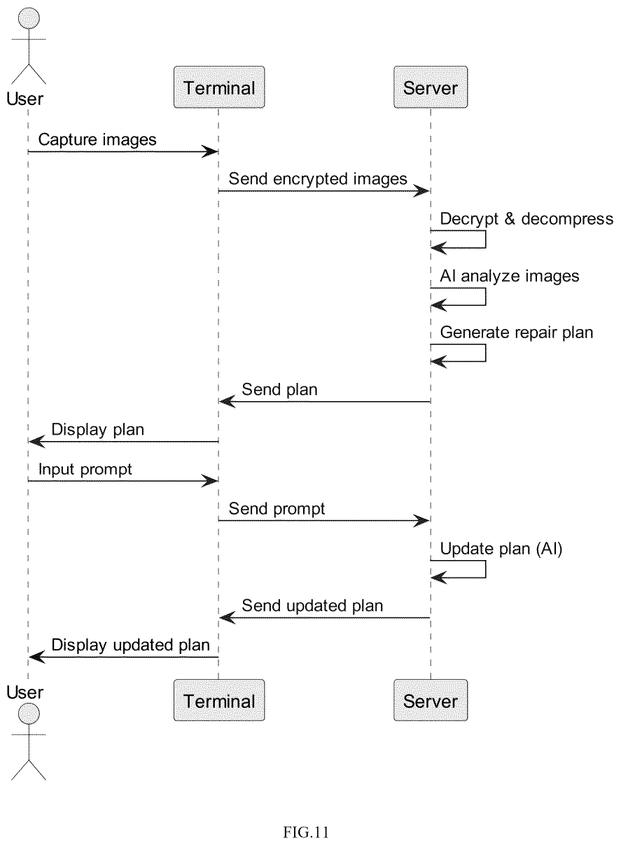

The following describes the processing flow using FIG. 11.

### Step 1

The user operates a data acquisition device, such as a smartphone or drone, to capture high-resolution images or videos of a target facility from various angles. The input is the physical structure, and the output is digital image information representing the condition of the facility. The user ensures important areas, such as joints and stress points, are included during the capture process.

### Step 2

The terminal receives the image information from the data acquisition device. The terminal compresses the image files using a lossless compression method, such as ZIP or PNG, and encrypts the data using an algorithm like AES. The input is raw image data, and the output is compressed and encrypted image data. The terminal then transmits the processed image data to the server using a secure communication protocol (e.g., HTTPS).

### Step 3

The server receives the compressed and encrypted image data from the terminal. The server decrypts the data using the correct decryption keys and decompresses the files to restore the original images. The input is compressed and encrypted image data, and the output is decompressed, decrypted image information ready for analysis. The server organizes the images by project and prepares them for AI processing.

### Step 4

The server processes the restored image information using a generative AI model implemented with software such as PyTorch or TensorFlow. The server analyzes the image data for damage patterns, such as cracks or corrosion, by applying deep learning algorithms. The input is decompressed, decrypted image data, and the output is a list of detected damage locations, each annotated with the type and severity of deterioration. The server then stores this information for further processing.

### Step 5

The server evaluates the detected damages and prioritizes the repair locations using predefined rules and AI-based criteria, such as severity, risk, and structural importance. The input is the annotated damage list from the previous step, and the output is a prioritized repair list. The server then generates a reinforcement plan, including recommended repair processes, material requirements, and an optimized schedule. The server formats and stores the plan for delivery.

### Step 6

The server delivers the generated reinforcement plan to the user terminal using a web interface or app. The input is the generated reinforcement plan, and the output is the display of the plan on the user terminal. The server ensures that the plan is presented in a user-friendly and interactive format, allowing the user to review and understand the proposed actions.

### Step 7

The user reviews the reinforcement plan on the terminal. The user may input additional requirements or instructions as a prompt sentence, such as “Prioritize column repairs first” or “Create a plan within a budget of $10,000.” The input is a natural-language prompt sentence typed by the user, and the output is the transmission of this prompt to the server for further processing.

### Step 8

The server receives the prompt sentence from the user terminal and uses a generative AI language model, such as GPT-4, to interpret the instructions. Based on the user input, the server modifies the reinforcement plan by adjusting priorities, scheduling, or resource allocation as necessary. The input is the user prompt sentence along with the initial reinforcement plan, and the output is an updated reinforcement plan that reflects the user's requirements. The server then sends the revised plan back to the user terminal for final review.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Accurately assessing the deterioration state of structures such as buildings and infrastructure, efficiently creating optimal maintenance or reinforcement plans, and effectively communicating these plans to operators remains a significant challenge. Conventional methods often lack real-time feedback, objective prioritization, or the ability to adapt to the operators'emotional states, resulting in delays, increased costs, decreased safety, and lowered operator satisfaction. There is also a need for a seamless method to incorporate supplementary information and operator feedback, as well as for structured storage and utilization of maintenance results in disaster response scenarios.

The specific processing by the specific processing unit 290 of the data processing device 12 in Application Example 1 is realized by the following means.

The present invention provides a server comprising a processor configured to acquire visual information of a target structure, analyze the information using an identification model to assess deterioration, determine and prioritize maintenance tasks, generate comprehensive treatment plans, present the plans to an operator, estimate operator emotions, and automatically supplement the plans based on emotion data, while accepting operator feedback and storing integrated data for emergency response purposes. This enables accurate, efficient, and adaptive planning and execution of maintenance activities for structures and infrastructure, while improving operator understanding and satisfaction, and facilitating rapid disaster response through organized information management.

The term “processor” refers to an information processing unit configured to execute computational functions, data analysis, control operations, and logic sequences within the system.

The term “image acquisition device” refers to an apparatus, such as a camera or imaging sensor, capable of capturing visual information from a target structure for the purpose of analysis.

The term “visual information” refers to digital data representing the appearance or condition of a structure, obtained via image acquisition devices.

The term “identification model” refers to an algorithm or artificial intelligence model designed to evaluate, recognize, and classify features within visual information, such as deterioration patterns or structural anomalies.

The term “deterioration state” refers to the evaluated condition or status of a structure, indicating the presence, type, and severity of degradation or defects.

The term “maintenance target locations” refers to specific areas or regions of a structure identified as requiring repair, reinforcement, or maintenance as a result of deterioration analysis.

The term “task order” refers to the prioritized sequence in which maintenance, repair, or treatment tasks should be performed, determined by factors such as severity, importance, and operational constraints.

The term “treatment plan” refers to a comprehensive schedule or set of instructions specifying repair methods, materials, operational steps, and timing for addressing identified maintenance targets.

The term “information display device” refers to an apparatus or interface, such as a computer screen, mobile device, or other user interface, used to present information, plans, or instructions to an operator.

The term “operator” refers to an individual responsible for interacting with the system and executing, supervising, or managing maintenance or repair activities.

The term “emotion estimation process” refers to a technique or algorithm for analyzing operator responses, such as facial expressions, vocal cues, or behavioral signals, to determine emotional states relevant to maintenance planning.

The term “supportive information” refers to additional explanations, guidance, visual examples, or resources provided to assist the operator in understanding and implementing the treatment plan, particularly in response to detected emotional states.

The term “communication means” refers to hardware or software components that enable data exchange or messaging between the operator and the processor, such as wireless communication modules, networks, or communication protocols.

The term “storage device” refers to a digital memory or database system configured to retain data, such as identification results, treatment plans, and related information, for future retrieval and analysis.

The term “regional attributes” refers to geographic or locational information associated with a structure, such as coordinates, address, or zone, used for contextualizing maintenance records and supporting disaster response operations.

The term “emergency response planning” refers to the process of preparing and organizing information to facilitate rapid and effective actions in response to natural disasters, accidents, or other hazardous events impacting infrastructure.

### Embodiment for Implementing the Invention

The present invention may be implemented using a system including a server comprising a processor, at least one user terminal device (such as a smartphone or tablet), an image acquisition device (such as a built-in or connected digital camera), an information display apparatus, a storage device, and communication means (e.g., a wired or wireless network). The system is configured to automatically assess the deterioration of structures, prioritize maintenance requirements, generate and present optimal treatment plans, incorporate operator feedback, and utilize operator emotion estimation to enhance decision-making and communication.

The server operates as the central information processing unit. The server receives digital image data representing the visual condition of a physical structure, such as a building or an infrastructure component. These images are captured by the user, who utilizes the image acquisition device—for example, by taking photographs of areas of concern on the structure using the camera function of a smartphone. The terminal compresses and transmits the image data over a secure protocol, such as HTTPS, to the server.

Upon reception, the server preprocesses the visual data. Software libraries such as OpenCV are used for image denoising, resizing, and color normalization. Once preprocessing is complete, the server inputs the image data into an identification model implemented using a generative AI model. Frameworks such as TensorFlow or PyTorch may be employed to realize this AI functionality. The AI model classifies and quantifies deterioration features such as cracks, rust, deformations, or other anomalies—and outputs a deterioration state for each observed location.

Based on the identification result, the server extracts maintenance target locations and applies a prioritization algorithm. Factors for prioritization may include the severity of the deterioration, the functional importance of the affected area, maintenance history, and operator-specified constraints, such as available budget or operational hours. The server then generates a treatment plan incorporating appropriate repair processes, material recommendations, and an optimized schedule. The treatment plan is formatted using suitable document generation software and transmitted back to the information display device on the user terminal.

The user terminal presents the treatment plan to the operator in a visually understandable form, such as PDF or graphical summary. An emotion estimation process may be executed on the terminal, utilizing its camera and audio input in combination with emotion recognition software or third-party libraries, like Azure Face API or similar. The operator's reactions—such as facial expressions or voice—are analyzed and transmitted to the server as emotional data.

The server interprets the operator's emotional state using an emotion analysis model developed with machine learning methods. If necessary, the server supplements the presented plan by adding supportive information, for example, detailed guidance, frequently asked questions, or examples of successful repairs, especially when negative emotions (such as concern or confusion) are detected.

The system further enables the operator to transmit feedback or specific requests regarding the treatment plan (such as preferred timing or material choices) via the user terminal. The server processes this information, updates the plan accordingly, and returns the revised version to the terminal, facilitating an interactive and adaptive maintenance workflow.

All identification results and treatment plans, together with location and regional information, are stored in the storage device. This allows for efficient retrieval and application of accumulated maintenance data for emergency response and disaster management.

A practical example is as follows:

A user, who is the administrator of a public facility, detects a possible crack on a supporting wall. The user uses the facility management application on a tablet to photograph the wall and uploads the data to the server. The server analyzes the image using a generative AI model in TensorFlow, identifies the crack, assesses its severity, and assigns the location the highest repair priority. A treatment plan specifying resin repair and a two-day completion schedule is generated. The user reviews the plan through the application, which automatically analyzes the user's facial expression as anxious. In response, the server appends to the treatment plan a detailed explanation and success stories about similar repairs. The user requests that repairs only be conducted outside of business hours using the in-app form; the server receives this feedback, updates the schedule, and delivers the optimized plan to the user's device.

Example prompt sentence to the generative AI model:

“Analyze these high-resolution inspection images. Detect and classify all areas of deterioration, estimate severity scores, and generate a prioritized action plan including specific repair locations, recommended materials, and timing.”

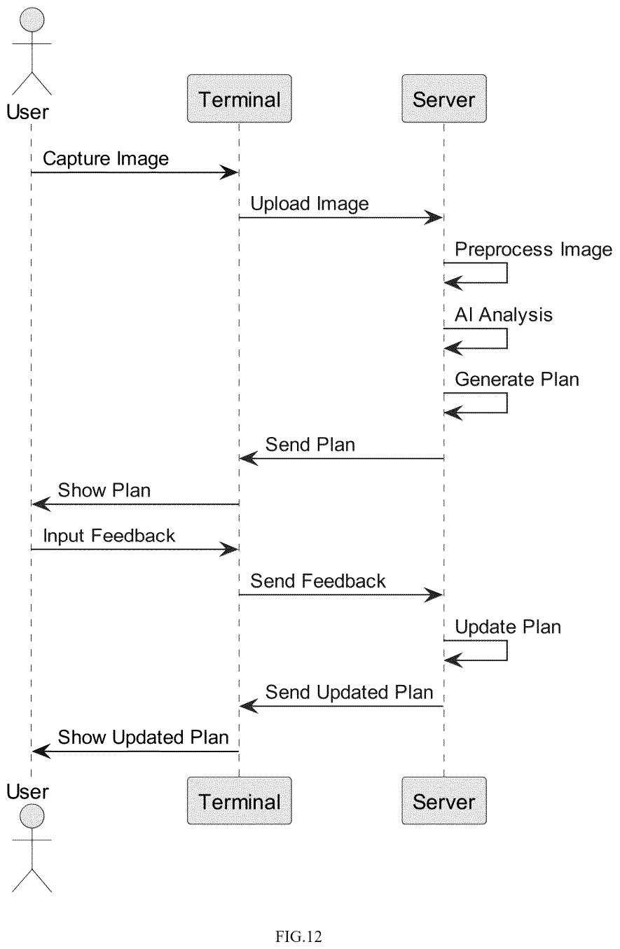

The following describes the processing flow using FIG. 12.

### Step 1

The user operates the image acquisition device, such as a smartphone camera, to capture high-resolution images of areas of concern on the target structure. The input is the real-world physical structure, and the output is a set of digital images saved on the terminal.

The user visually inspects the site, selects representative regions, and ensures adequate lighting and clarity during image capture.

### Step 2

The terminal compresses the captured images using a standard image compression algorithm (such as JPEG), attaches metadata including device ID, timestamp, and GPS location, and prepares the data for secure transmission. The input is the raw image files and contextual metadata, and the output is a compressed and packaged data file ready for upload. The terminal then establishes an HTTPS connection and uploads the data to the server, confirming transmission status to the user.

### Step 3

The server receives the uploaded data and verifies data integrity as well as proper image formatting. The input is the compressed image file with metadata received from the terminal, and the output is validated and preprocessed image data suitable for AI analysis. The server uses OpenCV to denoise the images, adjust the resolution, normalize color profiles, and, if needed, convert to grayscale.

### Step 4

The server passes the preprocessed images to a generative AI model implemented with a deep learning framework such as TensorFlow or PyTorch. The input is the cleaned image dataset, and the output is a set of detection results, including annotated defect locations, types (e.g., cracks, corrosion), and calculated severity scores. The server executes pattern recognition, feature extraction, and confidence scoring as internal operations.

### Step 5

The server analyzes the defect detection results to identify specific maintenance target locations and prioritizes them using an internal algorithm. The input is the annotated defect list with severity scores, and the output is a prioritized repair task list. The server considers parameters such as defect severity, location criticality, recent maintenance records, and any operator-specified constraints.

### Step 6

The server generates a detailed treatment plan based on the prioritized repair list. The input is the list of prioritized maintenance targets; the output is a digital treatment plan containing instructions, recommended materials, repair methods, and optimized work schedules. The server formats this plan as a PDF or interactive display document, attaches diagrams, and stores the details in the database.

### Step 7

The terminal receives the treatment plan and presents it to the user through a graphical interface, enabling the user to review, print, or annotate the plan. The input is the treatment plan file from the server, and the output is the displayed and interactive plan on the user's device. If emotion recognition is enabled, the terminal activates the device camera and microphone for emotion detection.

### Step 8

The terminal collects the user's facial expressions or voice samples while the user interacts with the treatment plan and sends this emotion data to the server for analysis. The input is user-generated audio/visual reaction data, and the output is a securely transmitted emotion dataset.

### Step 9

The server analyzes the incoming emotion data using an emotion estimation model. The input is the user's emotion dataset, and the output is a determination of emotional state (e.g., confidence, confusion, anxiety). If negative emotions are detected, the server supplements the treatment plan with additional explanations, case studies, or visual aids tailored to the detected emotional state.

### Step 10

The user submits feedback, requests, or additional instructions regarding the treatment plan via the terminal's input interface, such as a form or chat feature. The input is user-generated text or selection data, and the output is real-time feedback transmitted to the server.

### Step 11

The server processes the feedback or requests, updates the treatment plan if necessary (for example, by adjusting work schedules or changing materials), and sends the modified plan back to the terminal. The input is the feedback dataset; the output is the updated treatment plan provided to the user for final review and confirmation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional deterioration diagnosis systems for buildings and infrastructure mainly focus on technical evaluation and reinforcement planning, and do not sufficiently consider the psychological state of the user. As a result, users may experience anxiety or uncertainty regarding the proposed reinforcement plans, resulting in low satisfaction. Additionally, efficient integration of regional information and management of support information tailored to user emotions has been insufficient. There is therefore a need for a comprehensive system that not only performs advanced technical diagnostics but also provides user-centered emotional support and facilitates information management for disaster planning.

The specific processing by the specific processing unit 290 of the data processing device 12 in Example 2 is realized by the following means.

The present invention provides a server comprising a processor configured to acquire image information of a target structure, analyze the image information using a deep learning-based model to identify deterioration, assign priorities to repair areas, create a repair plan document, provide the repair plan document to a user via a terminal, acquire video or audio data from the user, analyze the data using an emotion recognition model, and provide support information tailored to the user's emotional state. The processor may also enable user input of additional information, and store diagnosis results and repair plan documents in association with regional information for disaster response planning. This enables not only accurate and efficient deterioration diagnosis and repair planning but also enhancement of user reassurance and satisfaction through emotion-driven support, as well as integrated management of technical and regional information.

The term “processor” refers to a data processing unit capable of executing instructions to perform various image analysis, emotion recognition, information management, and communication functions within the system.

The term “image acquisition information processing device” refers to a hardware device such as a camera-equipped terminal or computational unit configured to capture image information of a target structure.

The term “image information” refers to digital information representing visual data of a structure, typically in the form of electronic files such as JPEG or PNG format image files.

The term “deep learning-based information processing model” refers to a software-based artificial intelligence model employing layered neural network architectures for extracting and analyzing features from image information in order to identify deterioration.

The term “deterioration state” refers to a quantified or classified condition of a structure indicating the presence and extent of damage or degradation, as identified from image information.

The term “repair area” refers to a specific portion or region of a structure that is determined to require maintenance or reinforcement based on the identified deterioration state.

The term “priority” refers to the assigned order or ranking, according to the urgency or importance of required repair actions among multiple repair areas.

The term “repair plan document” refers to a structured file or digital information generated by the processor that describes recommended repair methods, target areas, procedural steps, resource estimates, and their priorities.

The term “information terminal” refers to an electronic device capable of displaying data, transmitting information, and enabling user interaction, such as a smartphone, tablet, or personal computer.

The term “video information” refers to moving image data captured from the user, typically using a camera integrated in the information terminal, which may reflect user reactions.

The term “audio information” refers to sound data, such as the user's speech or vocal responses, captured using a microphone embedded in the information terminal.

The term “emotion recognition information processing model” refers to an artificial intelligence model configured to classify or estimate a user's emotional state based on analysis of video information, audio information, or both.

The term “emotional state” refers to a psychological condition or feeling of the user, such as anxiety, reassurance, or confusion, as determined by the emotion recognition information processing model.

The term “support information” refers to additional information or content generated for the user, tailored to their emotional state, including but not limited to case studies, expert comments, or reassuring materials.

The term “data communication device” refers to an electronic device configured to transmit and receive additional information or user input over a network.

The term “storage device” refers to a memory unit or database in which diagnosis results, repair plan documents, and related regional or contextual information are stored for subsequent retrieval and use.

The term “regional information” refers to geographical, climatic, social, or economic data related to the location of the structure, which may be used in disaster response planning. The term “disaster response planning” refers to organized measures or strategies for preparing and responding to potential disasters, utilizing stored diagnostic and regional information.

The system is realized using a combination of a processor-equipped server, image acquisition information processing devices (such as smartphone cameras or digital cameras), information terminals (such as smartphones, tablets, or personal computers), and network-connected storage devices. The core software components include a deep learning-based information processing model (for example, using frameworks such as TensorFlow or PyTorch), an emotion recognition model (for example, using open-source libraries like TensorFlow Lite or commercial products such as Affectiva SDK), and dedicated application software installed on the information terminal for user interaction.

In this embodiment, the user utilizes an image acquisition device, such as the camera function on a smartphone, to capture digital images of a target structure. The information terminal, which may be a smartphone or portable computer, is configured to run a dedicated application that manages the workflow for data acquisition, review, and communication with the server. After capturing the image information, the application facilitates the upload of image files, such as JPEG or PNG formats, to a remote server via a wireless or wired network. The server receives the uploaded image information and inputs it to the deep learning-based information processing model. This generative AI model is trained to identify patterns and features indicative of deterioration, such as cracks, discoloration, deformation, or other aging phenomena in structural elements. The server processes the images, extracts feature data, and quantifies the extent and location of deterioration. Representative deep learning frameworks that can be adopted include TensorFlow and PyTorch.

Subsequently, the server analyzes the deterioration state and assigns priority to repair areas based on factors such as severity and risk, using embedded algorithms and decision templates. The server then generates a repair plan document, detailing recommended repair areas, prioritized actions, suggested methods, expected resources, and cost estimates. This repair plan document is transmitted to the user's terminal, where it can be displayed for user review.

During or after the user reviews the repair plan, the information terminal obtains video or audio information representing user reactions, such as facial expressions or spoken remarks, using the device's sensor hardware. With user consent, these data are uploaded to the server.

The server then utilizes the emotion recognition model to analyze the acquired video or audio information and determine the emotional state of the user. When the analysis detects emotions such as anxiety or confusion, the server selects, generates, or customizes support information. This support information may include explained examples of successful repairs, frequently asked questions, comments from professionals, or multimedia content, all tailored to increase reassurance and user understanding.

Optionally, the processor may allow the user to enter additional comments, requests for clarification, or supplementary data concerning the repair plan, through the application interface. These user inputs can be communicated to the server using the information terminal's communication functions.

Furthermore, the processor on the server stores the deterioration diagnosis results and repair plan documents in a networked storage device, associating them with regional information such as geographical, climatic, social, or economic data. This enables use of stored data for planning and response in disaster management scenarios.

For example, when a user wishes to diagnose the roof of a residential house, the user opens an application on their smartphone, takes photographs of the roof, and uploads these images to the server. The server, running a PyTorch-based deep learning model, detects cracks and discolors and generates a detailed repair plan. When the user studies this plan, the terminal records and uploads the user's facial reaction; the server's emotion recognition model detects concern and responds by providing a video testimonial and expert commentary to reassure the user and improve satisfaction.

An example of a prompt sentence provided to the generative AI model in this embodiment is as follows:

“This program combines an AI system for diagnosing building deterioration conditions with an emotion recognition engine. Based on information derived from image data, please identify deterioration areas, create a reinforcement plan, and provide user support by analyzing emotional cues.”

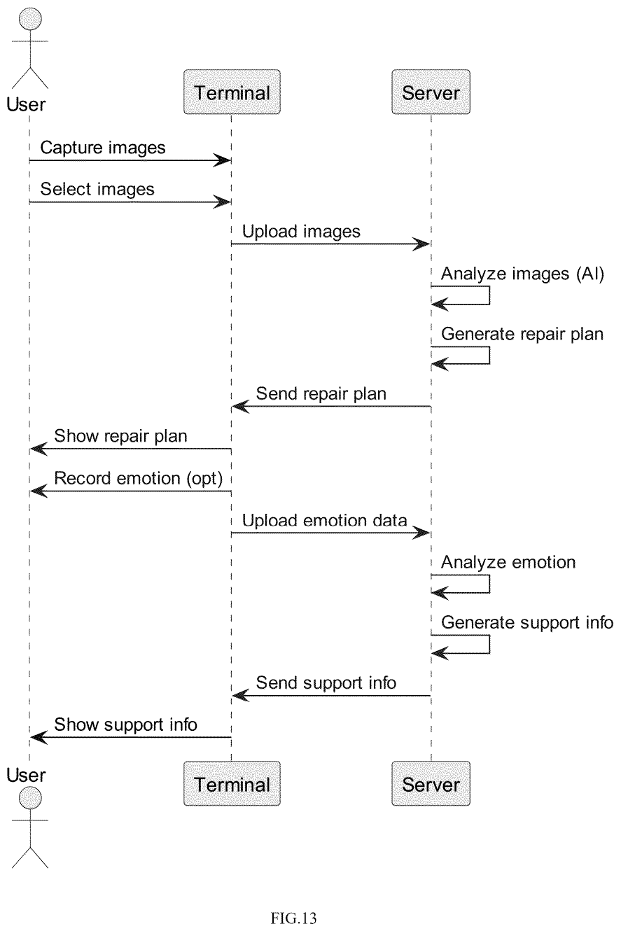

The following describes the processing flow using FIG. 13.

### Step 1

The user uses the information terminal (such as a smartphone or tablet) to open the dedicated application. The user captures image information of the target structure, for example by taking several photos of a building's wall or roof using the device's camera. The input is the real-world visual appearance of the structure; the output is a set of image files (e.g., JPEG or PNG format) stored on the device. The device processes camera sensor data into digital image files that are ready for upload.

### Step 2

The terminal displays a prompt for the user to select the images to be analyzed. The user selects the relevant image files within the application. The terminal establishes a data connection to the server via a network and transmits the selected images to the server using a secure protocol. The input is the selected image files; the output is the successful upload and server-side storage of the image data. The application compresses and packages the selected files for efficient and secure transmission.

### Step 3

The server receives the image files from the terminal. The server inputs the image data into the deep learning-based generative AI model (implemented, for example, in TensorFlow or PyTorch). The server performs image analysis by extracting features and detecting patterns corresponding to deterioration, such as cracks or stains. The server outputs deterioration state data, including location, type, and severity of detected issues. The server processes the pixel data, applies deep learning inference steps, and outputs a list of detected damages with their attributes.

### Step 4

The server evaluates the deterioration state data to identify which areas require repair. The server algorithmically assigns priority to each issue based on severity, urgency, and potential risk, using established rule sets and decision logic. The input is the structured deterioration data; the output is a prioritized repair list. The server categorizes the damage and sorts repair tasks by urgency before proceeding.

### Step 5

The server generates a repair plan document using a repair plan template. The plan includes details such as prioritized repair areas, recommended methods, materials, and estimated costs. The input is the prioritized repair list; the output is a digital repair plan document (for example, a PDF or a structured data file), assembled using server logic and template merging operations.

### Step 6

The server transmits the repair plan document to the user's terminal. The terminal receives the document and notifies the user with a message or alert. The input is the repair plan digital file; the output is the display of the plan on the terminal screen. The application formats and presents the relevant sections for easy review.

### Step 7

The user reviews the repair plan document on the terminal. While reviewing, the terminal, with the user's permission, activates its camera and/or microphone to record the user's facial expressions or voice responses. The terminal then generates brief video or audio files reflecting the user's emotional response. The input is the live sensor data; the output is emotion data files prepared for upload. The application manages the sensor activation, file creation, and privacy settings.

### Step 8

The terminal transmits the emotion data files to the server using a secure protocol. The server receives the files as input and processes them with the emotion recognition information processing model (for example, using TensorFlow Lite or Affectiva SDK). The server analyzes the data to determine the user's emotional state, such as anxiety, confusion, or reassurance. The output is classified emotional state data, derived from video or audio analysis using machine learning models.

### Step 9

The server generates support information, such as successful repair case studies or expert comments, tailored to the user's detected emotional state. The input is the determined emotional state; the output is a customized support information package. The server selects, formats, and bundles the information based on pre-set rules for emotional response mitigation.

### Step 10

The server transmits the support information package to the user's terminal. The terminal notifies the user and presents the information using video, audio, or text. The input is the digital support content; the output is the display or playback of information to the user. The application orchestrates the user experience and provides access to view or listen to the content.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In the inspection and maintenance of industrial equipment and infrastructures, accurate diagnosis of deterioration, formulation of optimal reinforcement plans, and appropriate user support based on users'emotional states are often inadequate. Conventional systems frequently fail to comprehensively identify deterioration states, prioritize repairs, propose effective action plans, and respond to users'anxiety or concerns during maintenance planning. As a result, maintenance may be delayed, efficiency may decrease, and user confidence or safety awareness may be compromised. Furthermore, there is a lack of mechanisms to flexibly provide suitable supplemental information or case studies in response to user emotions, and to systematically store and utilize inspection and reinforcement data for disaster response.

The specific processing by the specific processing unit 290 of the data processing device 12 in Application Example 2 is realized by the following means.

The present invention provides a server comprising a processor configured to acquire image information of a target object, analyze the image information using a machine learning model to identify a deterioration state, extract repair target locations and assign priorities, generate reinforcement work plan information through an optimization process, present this information to a user device, acquire and analyze the user's emotion information in response, provide additional or case-based information based on detected emotions, and, when necessary, utilize a generative information processing model to supply further support information. The server is further configured to store the integrated deterioration identification results, reinforcement plans, user emotion information, and regional data as disaster response resources. This enables accurate deterioration diagnosis, dynamic planning of optimal reinforcement work, and adaptive information provision and user support based on emotional analysis, contributing to more efficient maintenance operations and improved user reassurance.

The term “processor” refers to a computing unit configured to execute instructions and perform data processing tasks required by the system.

The term “information acquisition device” refers to any hardware device capable of capturing image information of a target object, such as a camera, imaging sensor, or similar equipment.

The term “image information” refers to digital data representing visual characteristics of a target object, typically in the form of photographs or video frames.

The term “machine learning model” refers to a computational structure trained on data to automatically analyze and interpret patterns in the image information, including, but not limited to, artificial intelligence algorithms and neural networks.

The term “deterioration state” refers to the condition or degree of damage, wear, or degradation present in a target object as determined by analysis of image information.

The term “repair target location” refers to a specific position or area within the target object identified as requiring repair or maintenance.

The term “priority” refers to a relative ranking or order assigned to repair target locations based on factors such as severity or urgency of deterioration.

The term “reinforcement work plan information” refers to a structured set of instructions, schedules, or procedures formulated to implement repair or reinforcement actions on the identified target object.

The term “optimization method” refers to a process or algorithm used to generate the most efficient or effective reinforcement work plan based on given constraints and priorities.

The term “user device” refers to an electronic terminal operated by the user to receive and display information, including but not limited to mobile terminals, computers, or similar interface devices.

The term “emotion information” refers to data indicative of a user's emotional state, detected through analysis of visual, audio, or textual input obtained from the user.

The term “additional information” refers to supportive data, explanations, or instructions provided in response to the user's emotion information to address concerns or enhance understanding.

The term “case information” refers to documented examples or case studies relevant to the reinforcement or repair of similar target objects.

The term “information processing device” refers to a system component capable of performing operations on collected data, including emotion analysis, information selection, and user support.

The term “generative information processing model” refers to an artificial intelligence system configured to generate responses, explanations, or support information based on input data, including, but not limited to, language models and generative algorithms. The term “support information” refers to any information generated or selected for presentation to the user to facilitate understanding, reduce anxiety, or aid decision-making during repair or reinforcement planning.

The term “integrated information” refers to combined and structured data comprising identification results, reinforcement work plan information, emotion information, and regional information, aggregated for storage or further utilization.

The term “regional information” refers to data pertaining to the location or environment in which the target object is situated, which may be relevant for maintenance or disaster response planning.

The term “information recording device” refers to hardware or media capable of storing data, including integrated information, for retrieval and use in future analysis or planning.

The term “disaster response resources” refers to information and planning tools prepared and stored for use in the event of a disaster, facilitating timely and effective maintenance actions.

An embodiment for implementing the present invention will now be described. The system described in this specification includes a server equipped with a processor, one or more user-operated terminals, an information acquisition device such as a camera, and information storage devices. The core of the invention lies in how the server, in cooperation with the terminal and user, processes and analyzes image information of a target object, derives optimal reinforcement plans, and provides adaptive user support based on emotional feedback.

The user uses a terminal equipped with a camera (such as a smartphone, tablet, or specialized inspection device) to acquire image information of an industrial device, infrastructure, or other target object. The terminal may use a built-in or connected camera module, and supplementary information such as geolocation and timestamp can be included through standard functionalities available in modern mobile terminals. The terminal transmits the captured image data and metadata to the server using a secure communication protocol such as HTTPS.

The server, upon receiving image information, utilizes information processing software such as open-source image processing libraries and machine learning frameworks (for example, OpenCV and a deep learning framework such as TensorFlow), to analyze the image data. The server's processor applies a machine learning model to detect, identify, and quantify deterioration states within the image, such as corrosion, cracks, or other faults. The server identifies the points requiring repair, calculates a priority score for each repair target location according to predefined rules, and generates a comprehensive reinforcement work plan for the identified issues using an optimization method implemented by planning software (e.g., a custom scheduling algorithm or commercially available project planning tool).

The server presents the reinforcement work plan information to the user via the terminal. The terminal receives and displays the plan using an application that typically provides summaries, risk explanations, annotated images, and step-by-step instructions.

To adaptively support the user, the server acquires emotion information from the user in response to the presented plan. The terminal uses its camera and/or microphone to capture the user's facial expressions and voice, transmitting the data to the server, where emotion analysis software (for example, an emotion recognition engine) identifies the user's emotional state. If the server detects indications of anxiety, concern, or other emotions, it automatically selects and sends additional explanation, related case studies, or other supplementary information to the terminal. Such information may include prior successful repair examples, causes of deterioration, or tips for prevention.

If the detected issue or the user's needs require deeper knowledge or a novel explanation, the server may construct a prompt and interact with a generative AI model to retrieve further support information. For example, if the server encounters an unknown form of rust in an image, it creates a prompt such as:

“Explain the best mitigation approach for an unfamiliar type of surface corrosion detected in a thermal power plant, and offer guidance for operator communication based on user anxiety.”

The server receives a generated response from the generative AI model and presents pertinent parts of the answer to the user via the terminal.

All recognized deterioration states, generated reinforcement plans, user emotional responses, and relevant regional information are stored by the server in an information recording device (such as a database or cloud storage). This aggregated information can later be used for broader maintenance optimization, responding to potential disasters, or improving future diagnostic accuracy.

In summary, the present invention enables accurate deterioration analysis, dynamic prioritization and planning for reinforcement work, and flexible adaptation of user support using combinations of information acquisition hardware, information processing software (including machine learning and generative AI models), and secure data storage methods. The system is also designed to be extendable to various inspection and maintenance situations in different facility types.

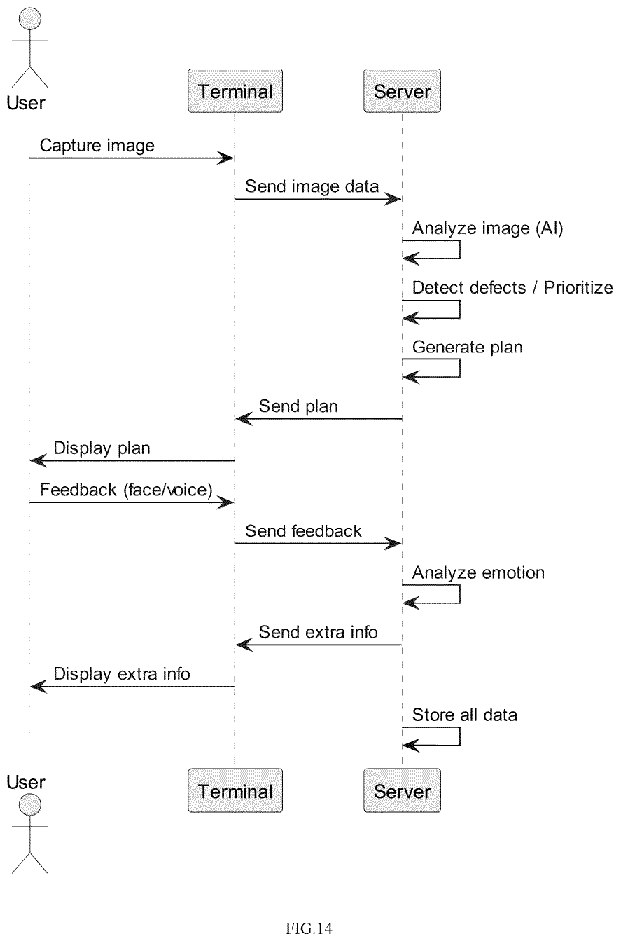

The following describes the processing flow using FIG. 14.

### Step 1

User uses the terminal to capture an image of a target object, such as a piece of equipment or infrastructure, using the camera function. The terminal collects the image data, supplements it with metadata (such as location and timestamp), and displays a confirmation screen. Input: visual data from the camera; Output: image file with metadata ready for transmission.

### Step 2

Terminal establishes a secure connection with the server and transmits the image file and metadata using a communication protocol such as HTTPS. Input: image file with metadata; Output: image data received by the server.

### Step 3

Server receives and stores the image data in storage hardware. The server parses the metadata and queues the file for analysis. Input: received image file and metadata; Output: stored data entry with associated metadata.

### Step 4

Server processes the image data using an image analysis pipeline that incorporates a machine learning model built with software such as OpenCV and a deep learning framework. The server applies filters and algorithms to detect regions of deterioration, such as corrosion or cracks. The processing includes segmenting the image, extracting feature vectors, and classifying faults. Input: raw image data; Output: deterioration detection results, including defect type, location, and severity.

### Step 5

Server calculates a priority score for each detected defect using an optimization algorithm based on rules (such as criticality, scale, or potential risk). The server produces a ranked list of repair target locations. Input: defect detection results; Output: prioritized list of repair locations with associated scores.

### Step 6

Server generates a reinforcement work plan by applying a planning algorithm to determine specific actions, schedule, required resources, and instructions for each prioritized defect. The server formats the plan for user comprehension. Input: prioritized list of repair locations; Output: structured reinforcement work plan.

### Step 7

Server sends the reinforcement work plan to the terminal, which notifies the user. The terminal displays the plan in an intuitive layout that may include text, annotated images, and timelines. Input: reinforcement work plan from the server; Output: displayed maintenance plan on the terminal.

### Step 8

Terminal prompts the user to review the plan and allows the user to enable the device's camera and microphone. User reads and considers the plan, while the terminal collects image and audio data reflecting the user's reactions. Input: user feedback (face and voice data); Output: feedback data sent to the server.

### Step 9

Server analyzes the feedback data using emotion recognition software, extracting features from facial expressions and voice, and classifies the user's emotional state (such as anxiety or confusion). Input: face and voice data from the terminal; Output: user emotion classification result.

### Step 10

Server decides if supplemental explanation or example cases are needed based on the emotion analysis. If appropriate, the server selects information from its knowledge base or, for novel issues, generates a prompt for a generative AI model to obtain expert explanations or guidance. For example, the server can use a prompt such as:

“Explain the best mitigation approach for an unfamiliar type of surface corrosion detected in an industrial facility, and recommend communication for an anxious operator.”

The server processes the generative AI model's output and prepares content for the user. Input: emotion classification result, optional prompt to generative AI; Output: selected or generated supplemental information.

### Step 11

Server transmits the supplemental information to the terminal. The terminal displays the information, such as additional text, visual aids, or case studies, to the user for reassurance or further guidance. Input: supplemental information from the server; Output: supplemental details presented to the user.

### Step 12

Server integrates all data from the process—deterioration identification results, reinforcement work plans, user emotion data, and regional metadata—into an information recording device. Input: all collected and processed data; Output: aggregated, structured records stored for future use in maintenance planning or disaster response.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

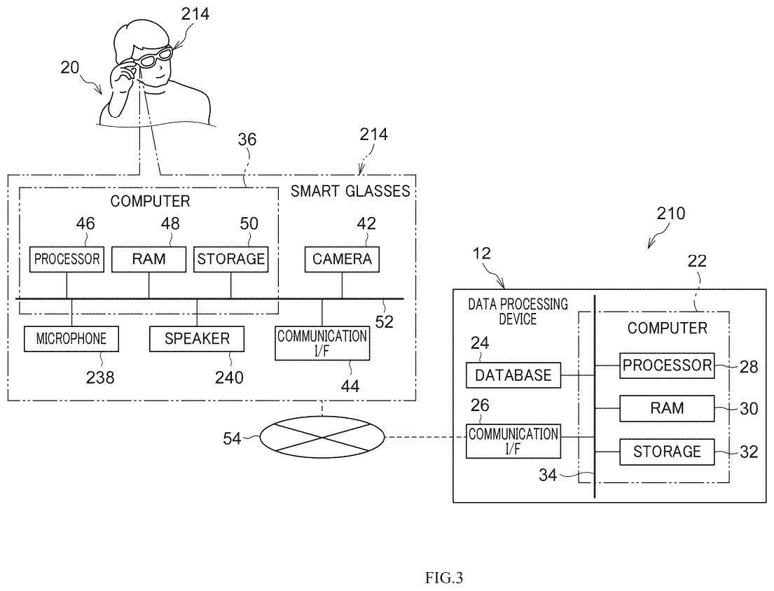

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

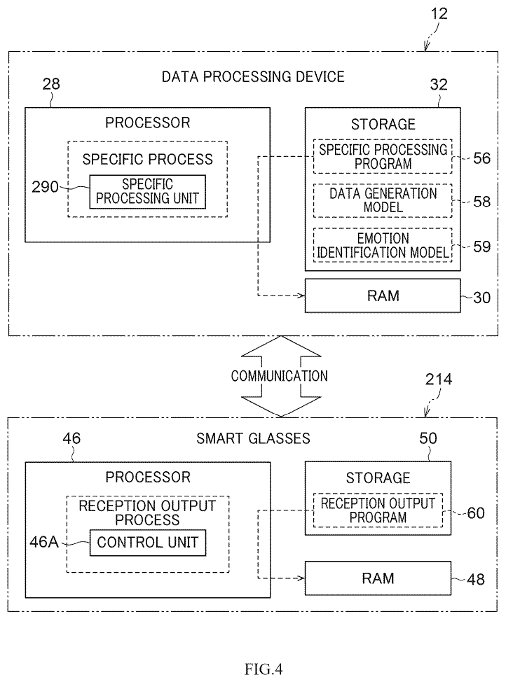

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

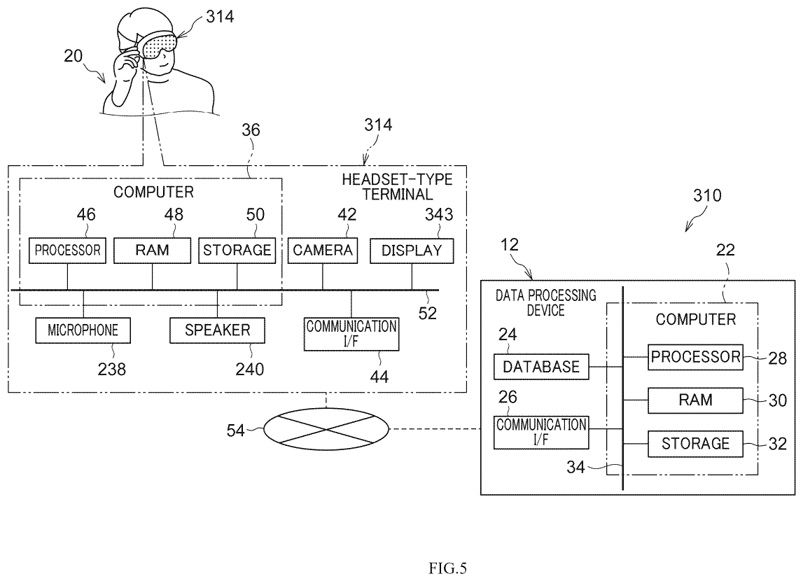

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

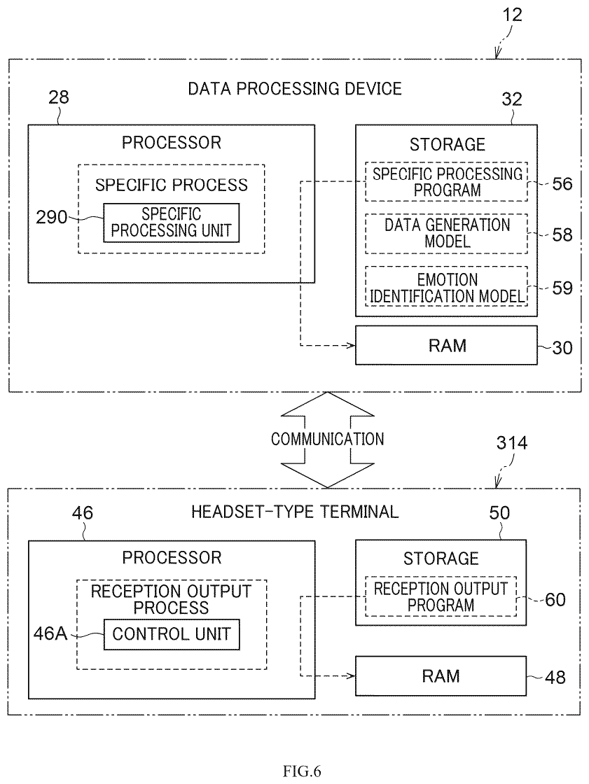

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12.

For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

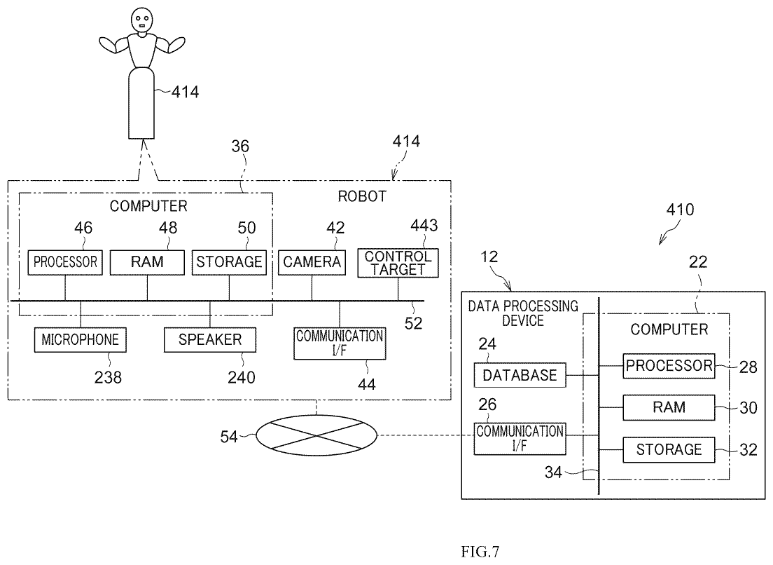

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

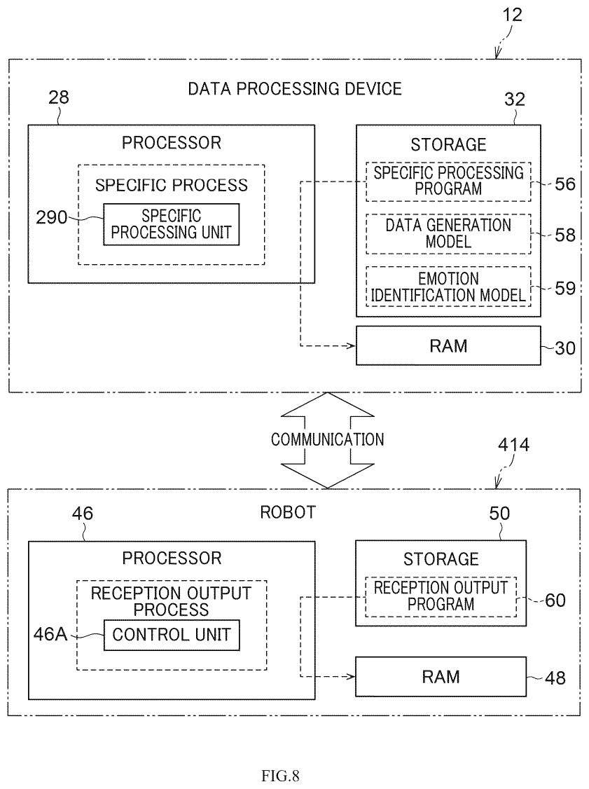

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

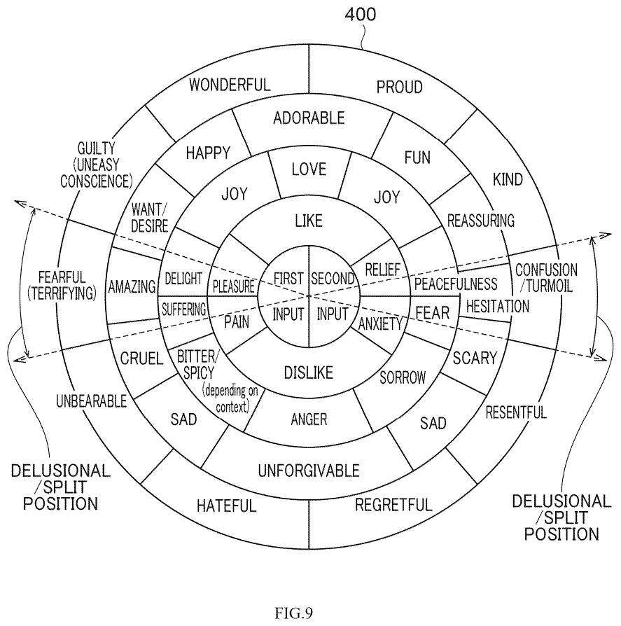

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more”and “want to know more”is experienced.

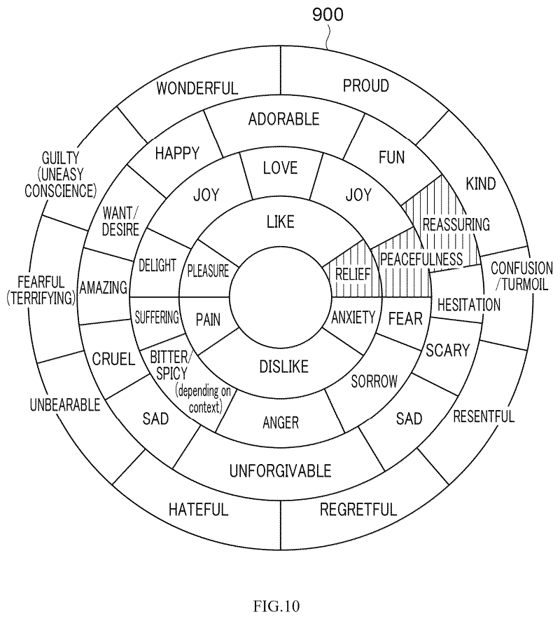

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured”are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire image information indicating a condition of a target facility using a data acquisition device,
transmit the image information to a data processing device and perform encryption and compression of the image information,
decrypt and decompress the received image information in the data processing device and convert the image information into a format suitable for analysis,
analyze the image information automatically using a generative artificial intelligence model to identify damage patterns,
identify repair locations based on the analysis result and automatically assign priorities according to the importance of each location,
generate a reinforcement plan including repair processes, material information, and work schedules based on the prioritized repair locations, and
provide the reinforcement plan to a user terminal via a user interface.

### Supplementary 2

The system according to supplementary 1,
wherein the processor is configured to
allow a user to input an instruction sentence or request sentence regarding the reinforcement plan via the user terminal, and reflect the contents of the instruction sentence in the reinforcement plan by analysis with the generative artificial intelligence model.

### Supplementary 3

The system according to supplementary 1,
wherein the processor is configured to store the analysis result and reinforcement plan in association with area information in a data set, and enable the use of such data in emergency response plans.

### Application Example 1

### Supplementary 1

A system comprising a processor,
wherein the processor is configured to
acquire visual information of a target structure by using an image acquisition device,
analyze the visual information by utilizing an identification model to determine a deterioration state of the structure,
extract maintenance target locations according to the determined deterioration state and determine a task order based on importance,
generate a treatment plan including process steps, materials to be used, and a work schedule according to the determined task order,
present the treatment plan to an operator via an information display device,
obtain reaction information of the operator by an emotion estimation process, and
automatically append additional or supportive information to the treatment plan based on the acquired emotion information.

### Supplementary 2

The system according to supplementary 1,
wherein the processor is configured to
enable the operator to input requests or additional information related to the treatment plan via a communication means and transmit the input to the processor.

### Supplementary 3

The system according to supplementary 1,
wherein the processor is configured to
store the identification result and the treatment plan in association with location information or regional attributes in a storage device, and enable use of the stored information for emergency response planning.

### Example 2

### Supplementary 1

A system comprising a processor,
wherein the processor is configured to
acquire image information of a target structure by using an image acquisition information processing device,
analyze the image information by using a deep learning-based information processing model to identify a deterioration state of the target structure,
specify repair areas and assign priority based on the identified deterioration state, create a repair plan document according to the assigned priority,
provide the repair plan document to a user via an information terminal,
acquire video information or audio information from the user during or after the user reviews the repair plan document,
analyze the video information or audio information by using an emotion recognition information processing model to determine an emotional state of the user, and
generate and provide support information aimed at improving a sense of reassurance of the user based on the emotional state via the information terminal.

### Supplementary 2

The system according to supplementary 1,
wherein the processor is configured to enable the user to input additional information related to the repair plan document or the support information via a data communication device.

### Supplementary 3

The system according to supplementary 1,
wherein the processor is configured to store the identified deterioration state and the repair plan document in association with geographical information, climate information, social information, or economic information in a storage device, and to make said information available for disaster response planning.

### Application Example 2

### Supplementary 1

A system comprising a processor,
wherein the processor is configured to
acquire image information of a target object using an information acquisition device, analyze the image information by applying a machine learning model to identify a deterioration state of the target object,
extract a repair target location and assign a priority based on the identification result,
generate reinforcement work plan information using an optimization method based on the assigned priority,
present the reinforcement work plan information to a user device,
acquire emotion information of the user and provide additional information or case information based on the emotion information,
select information to be provided by analyzing the emotion information using an information processing device,
transmit input information to a generative information processing model when necessary, and present generated support information to the user device.

### Supplementary 2

The system according to supplementary 1,
wherein the processor is configured to
enable a user to input information regarding the reinforcement work plan information or additional information using the user device.

### Supplementary 3

The system according to supplementary 1,
wherein the processor is configured to
integrate the identification result, the reinforcement work plan information, the user's emotion information, and regional information, and store this integrated information in an information recording device to make it available as a response work plan in case of a disaster.

What is claimed is:

1. A system comprising a processor,
wherein the processor is configured to:
acquire image data of a target structure using an image acquisition device,
analyze the image data using artificial intelligence to determine a deterioration condition of the structure,
identify repair locations and assign priorities based on the analysis result,
generate an optimal reinforcement plan based on the assigned priorities, and
present the reinforcement plan to a user.

2. The system according to claim 1,
wherein the processor is further configured to allow the user to input additional information regarding the reinforcement plan by using a communication device.

3. The system according to claim 1,
wherein the processor is further configured to integrate the analysis result and the reinforcement plan with regional information and to store them in a database for use in response planning in the event of a disaster.
